(19) United States
(12) Patent Application Publication
(10) Pub. No.: US 2014/0015850 A1
(43) Pub. Date: Jan. 16, 2014

(54) COLOR TRANSFORMATION METHOD AND APPARATUS FOR PERSON WITH COLOR VISION DEFECT

(71) Applicants: Korea University Research and Business Foundation, Seoul (KR); Samsung Electronics Co., Ltd., Gyeonggi-do (KR)

(72) Inventors: Sung-Joo AHN, Seoul (KR); Sung-Jea KO, Seoul (KR); Jung-Hoon PARK, Seoul (KR); Hang-Sik SHIN, Gyeonggi-do (KR); Hyun-Ji KIM, Seoul (KR); Jae-Yun JEONG, Seoul (KR); Hyun-Guk YOO, Gyeonggi-do (KR)

(21) Appl. No.: 13/939,681

(22) Filed: Jul. 11, 2013

(30) Foreign Application Priority Data
Jul. 11, 2012 (KR) 10-2012-0075532
Aug. 8, 2012 (KR) 10-2012-0086746

(51) Int. Cl. G06T 11/00

(52) U.S. Cl. CPC G06T 11/001
USPC 345/594

(57) ABSTRACT

A color transformation method and apparatus are provided for a person with a color vision defect. A color vision characteristic of a user is determined by receiving at least one of a kind of color vision defect and a degree of color vision defect selected by the user via a preset user color vision characteristic input menu. A preset basic hue table of a terminal is transformed according to the color vision characteristic of the user and transforming colors of a video to be displayed by applying the transformed basic hue table.

### PRIORITY

This application claims priority under 35 U.S.C. §119(a) to Korean Application Serial No. 10-2012-0075532, which was filed in the Korean Intellectual Property Office on Jul. 11, 2012, and to Korean Application Serial No. 10-2012-0086746, which was filed in the Korean Intellectual Property Office on Aug. 8, 2012, the contents of which are incorporated herein by reference.

### BACKGROUND OF THE INVENTION

1. Field of the Invention

The present invention relates generally to color transformation techniques used in a terminal, such as, for example, a cellular phone, a tablet, a notebook, a camera, a TV, and a Personal Digital Assistant (PDA), and more particularly, to a color transformation method and apparatus that transform colors of a video in the terminal for a person with a color vision defect.

2. Description of the Related Art

A color vision defect refers to a symptom in which colors are not properly distinguished due to, for example, a congenital function disorder of cone cells in a retina, acquired damage in cone cells in a retina, or a disorder in a visual pathway. Colors recognized by a normal person may be expressed by a combination of Red, Green, and Blue (RGB), which are three monochromatic rays. When one of three cone cells of red, green, and blue functions incompletely, it is referred to as color weakness, and when only two cone cells work properly it is referred to as color blindness.

A screen of a terminal makes use of various colors. However, a person with a color vision defect has more difficulty in distinguishing colors. In addition, when contents should be recognized by colors, the person with a color vision defect may not recognize the contents. Therefore, in a conventional device, a color transformation technique has been used that transforms colors into colors that can be distinguished by a person with a color vision defect.

In an example of a color transformation technique, Y. Ma, X. Gu, and Y. Wang disclosed “Color discrimination enhancement for dichromats using self-organizing color transformation, Information Sciences, 2009, vol. 179, pages. 830-843” to present a technique of transforming colors using a code book prepared in advance by using a Self Organizing Map (SOM), as illustrated in FIG. 1.

In addition, S. L. Ching and M. Sabudin disclosed “Website image colour transformation for the colour blind, 2nd International conference on Computer Technology and Development, Cairo, 2010, pages. 255-259” to present a technique of transforming colors by analyzing RGB components of pixels, as illustrated in FIG. 2. Specifically, color transformation is performed by applying a color transformation technique similar to that of FIG. 1, however, the process of the SOM is substituted for a method of transforming colors in an RGB color space and Hue, Saturation, and Value (HSV) color space, so that colors may be transformed more quickly than as shown in FIG. 1. Therefore, the color transformation method may be used in a website in which colors in a video are required to be transformed quickly.

In the conventional techniques described above, colors to be transformed are determined in advance, and the color transformation is performed. Therefore, the color transformation may not be performed according to the individual characteristics of a person with a color vision defect. In addition, if a video with color transformation using the conventional techniques is seen by a person with color weakness, the degree of the color transformation in the transformed video may be excessive. Accordingly, the conventional techniques may not be applied for people who have color weakness, that is, are not color blind, but can distinguish colors, because the ability to distinguish colors is different from individual to individual. In addition, it is not appropriate to apply the conventional technique that transforms colors regardless of the ability in distinguishing colors to a terminal carried and used by an individual, such as a mobile device.

### SUMMARY OF THE INVENTION

The present invention has been made to address at least the above problems and/or disadvantages and to provide at least the advantages described below. Accordingly, an aspect of the invention provides a color transformation method and apparatus for a person with a color vision defect, which transforms colors so that each person with a color vision defect can watch a video appropriately transformed according to an ability of an individual in distinguishing colors.

Another aspect of the present invention is to provide a color transformation method and apparatus for a person with a color vision defect, which is appropriate for a terminal carried and used by an individual such as a mobile device.

In accordance with an aspect of the present invention, a color transformation method is provided for a person with a color vision defect. A color vision characteristic of a user is determined by receiving at least one of a kind of color vision defect and a degree of color vision defect selected by the user via a preset user color vision characteristic input menu. A preset basic hue table of a terminal is transformed according to the color vision characteristic of the user and transforming colors of a video to be displayed by applying the transformed basic hue table.

In accordance with another aspect of the present invention, a machine-readable storage medium is provided that stores a program that performs the color transformation method for a person with a color vision defect, which when executed implements the steps of: determining a color vision characteristic of a user by receiving at least one of a kind of color vision defect and a degree of color vision defect selected by the user via a preset user color vision characteristic input menu; and transforming a preset basic hue table of a terminal according to the color vision characteristic of the user and transforming colors of a video to be displayed by applying the transformed basic hue table.

In accordance with a further aspect of the present invention, a hue transformation apparatus is provided for a person with color vision defect. The apparatus includes an input unit that receives control command from a user, and a video display unit that displays a video. The apparatus also includes a controller that generally controls each functional unit and comprises a color vision characteristic determining unit that determines a color vision characteristic of a user by receiving at lest one of a kind of color vision defect and a degree of color vision defect selected by the user through a preset user color vision characteristic input menu via the input unit, and a video hue transformation unit that transforms a preset basic hue table of a terminal according to the color vision characteristic of the user and transforms colors of a video to be displayed on the video display unit by applying the transformed basic hue table.

In order to achieve this, an aspect of the present invention provides a color transformation method for a person with a color vision defect. The method includes determining a color vision characteristic of a user by receiving an input or a selection of a kind of color vision defect or a degree of color vision defect selected by the user by executing a preset user color vision characteristic input menu; and transforming a preset basic hue table of a terminal according to the color vision characteristic of the user and transforming colors of a video to be displayed by applying the transformed basic hue table.

Transforming the basic hue table includes performing a configuration so that an entire hue scope of the HSV (Hue Saturation Value) color space is divided into a plurality of hue sections by 60 degrees; determining a CVD parameter that designates a reduction degree of the hue sections and a user hue parameter that designates the expansion degree of the hue sections according to the determined color vision characteristic of the user; and transforming and storing a basic hue table in the HSV color space by applying the determined CVD parameter and the determined user hue parameter, wherein reducing and expanding the hue sections is to reduce or expand an initially configured hue scope and to change HSV values corresponding to values at both ends of the initial hue scope in the hue sections to correspond to values at both ends of the reduced or expanded hue scope in the hue sections.

Transforming the colors of the video to be displayed includes transforming video pixel RGB (Red Green Blue) values of the video to be displayed to an HSV (Hue Saturation Value) color space; transforming hues of the video to be displayed by using the transformed basic hue table in the HSV color space; and transforming the HSV color space back to the video pixel RGB values.

Another aspect of the present invention includes a hue transformation apparatus for a person with a color vision defect. The apparatus includes an input unit that receives control command from a user; a video display unit that displays a video; and a controller that generally controls each functional unit and comprises a color vision characteristic determining unit that determines a color vision characteristic of a user by receiving an input or a selection of a kind of color vision defect or a degree of color vision defect selected by the user by executing a preset user color vision characteristic input menu via the input unit, and a video hue transformation unit that transforms a preset basic hue table of a terminal according to the color vision characteristic of the user and transforms colors of a video to be displayed on the video display unit by applying the transformed basic hue table.

The video hue transformation unit includes a basic hue table transformation unit that transforms and stores a basic hue table having preset hue information of the terminal according to the color vision characteristics of the user determined by the color vision characteristic determining unit; an RGB/HSV transformation unit that transforms video pixel RGB (Red Green Blue) values of a video to be displayed into an HSV (Hue Saturation Value) color space; a hue transformation unit that transforms a video hue of a video to be displayed by using the transformed basic hue table in the HSV color space; and an HSV/RGB transformation unit that transforms the HSV color space back to the video pixel RGB values.

### BRIEF DESCRIPTION OF THE DRAWINGS

The patent or application file contains at least ten drawings executed in color. Copies of this patent or patent application publication with color drawing(s) will be provided by the Office upon request and payment of the necessary fee.

The above and other aspects, features, and advantages of the present invention will be more apparent from the following detailed description when taken in conjunction with the accompanying drawings, in which:

FIG. 1 is a flowchart illustrating a color formation method using an SOM;

FIG. 2 is a flowchart illustrating RGB division color transformation;

FIG. 3 is a block diagram illustrating a color transformation apparatus for a person with color vision defect, according to an embodiment of the present invention;

FIG. 4 is a detailed block diagram illustrating a video hue transformation unit of FIG. 3, according to an embodiment of the present invention;

FIG. 5 is a flowchart illustrating a process of determining color vision characteristics in a color formation operation for a person with a color vision defect, according to an embodiment of the present invention;

FIG. 6 is a flowchart illustrating a process of transforming video colors in a color transformation operation for a person with a color vision defect, according to an embodiment of the present invention;

FIG. 7 is a graph illustrating an example of presenting hues of a basic hue table applied in an embodiment of the present invention with RGB values;

FIGS. 8A to 8C are graphs illustrating examples of hue recognition states of a person with a color vision defect and a normal person;

FIGS. 9A and 9B are graphs illustrating examples of presenting a standard hue value with hue values and RGB values in order to describe transformation of a basic hue table, according to an embodiment of the present invention;

FIGS. 10A and 10B are graphs illustrating examples presenting hues recognized by a normal person and a person with red-green blindness with HSV values;

FIGS. 11A to 11D are graphs illustrating examples of transforming a hue section which is indistinguishable and recognized as the same color by a person with a color vision defect in the case of red-green blindness, according to an embodiment of the present invention;

FIGS. 12A to 12D are graphs illustrating examples of transforming a hue section which is not distinguished according to a kind of color vision defect, in the case of red-green blindness, according to an embodiment of the present invention;

FIGS. 13A and 13B are graphs illustrating examples of presenting hues in a basic hue table and a transformed basic hue table of red-green blindness, according to an embodiment of the present invention;

FIGS. 14A to 14D are diagrams illustrating examples of a video before and after hue transformation;

FIGS. 15A and 15B are graphs illustrating an example of a hue section in which values of colors seen by a person with red-green color blindness are lower than values of colors seen by a normal person, according to another embodiment of the present invention;

FIG. 16 is a graph illustrating an example of presenting a change in values with respect to hues according to the degree of color vision defect in the case of red-green blindness, according to another embodiment of the present invention;

FIG. 17 is a detailed block diagram illustrating a video hue transformation unit in the case of a red-green color vision defect, according to another embodiment of the present invention;

FIG. 18 is a flowchart illustrating a process of transforming video colors in a color transformation operation for a person with red-green color vision defect, according to another embodiment of the present invention;

FIG. 19 is a detailed block diagram illustrating a video hue transformation unit in the case of a blue color vision defect, according to another embodiment of the present invention; and

FIG. 20 is a flowchart illustrating a process of transforming video colors in the color transformation operation for a person with a color vision defect in the case of the blue color vision defect, according to another embodiment of the present invention.

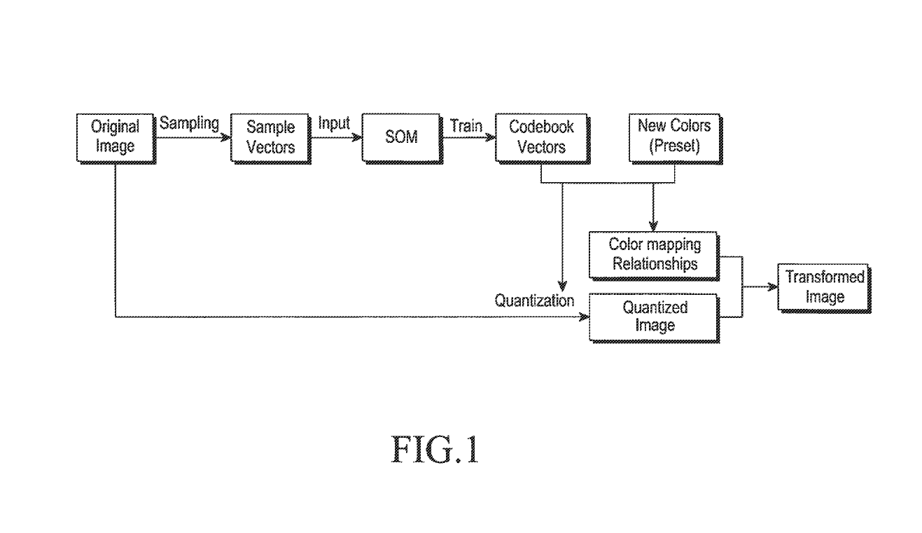

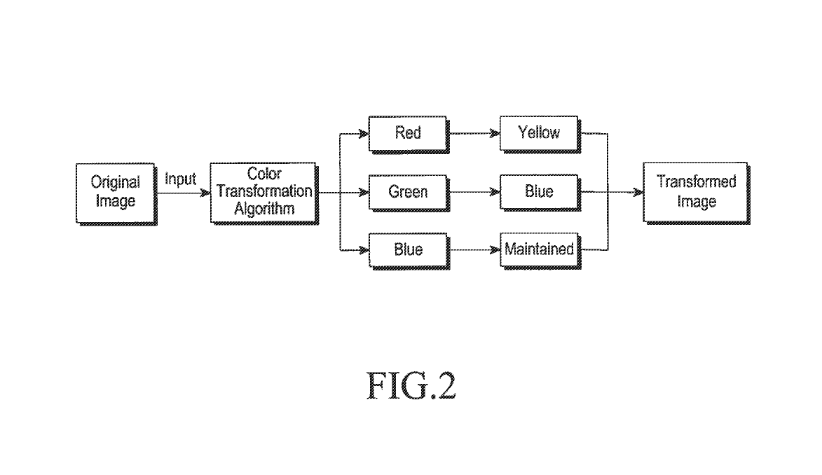

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Further, various specific definitions found in the following description are provided only to help general understanding of the present invention. Detailed descriptions of constructions or processes known in the art may be omitted to avoid obscuring the subject matter of the present invention.

Embodiments of the present invention are directed to a person with color weakness and a person with color blindness who cannot clearly distinguish two colors, and in embodiments of the present invention, color weakness and color blindness are collectively referred to as a color vision defect. Color blindness is caused when one of the cone cells does not exist, and color weakness is caused when one of cone cells is incomplete.

Examples of color blindness include red-green blindness, blue-yellow blindness, red blindness which lacks a red receptor, green blindness which lacks a green receptor, and blue blindness which lacks a blue receptor. Examples of color weakness include red-green weakness and blue weakness. The red-green weakness may be divided into red weakness and green weakness.

In addition, the degree of the color vision defect may be quantified from 0 to 1.0, according to the seriousness of the color vision defect. In the case of color blindness, the quantified value of the color vision defect is 1.0, and in the case of color weakness, the quantified values are between 0.1 and 0.9. A value closer to 0 indicates that the color vision defect is less serious and the value closer to 1.0 indicates that the color vision defect is more serious.

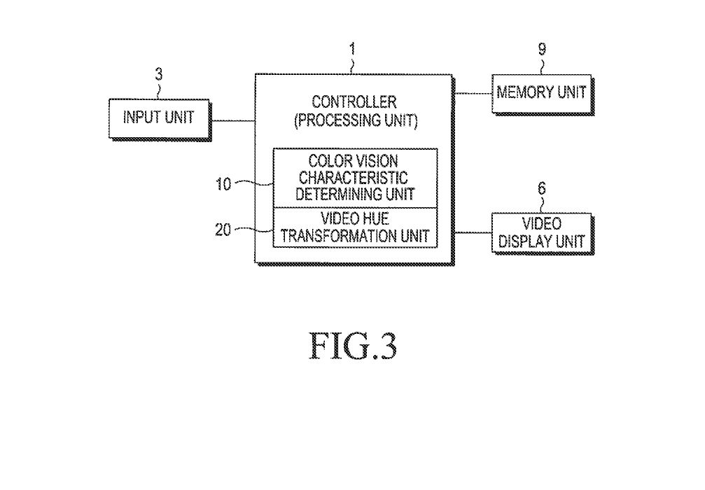

FIG. 3 is a block diagram illustrating a color transformation apparatus for a person with a color vision defect, according to an embodiment of the present invention. With reference to FIG. 3, the color transformation apparatus for a person with a color vision defect, according to an embodiment of the present invention, includes an input unit 3, a video display unit 6, a memory unit 9, and a controller 1.

The input unit 3 is an apparatus that receives control command from a user, and the input unit 3 may include at least one of a touch screen, a keyboard, a button, a mouse, and an input interface.

The video display unit 6 is an apparatus, such as, for example, a touch screen or a monitor, that displays a video, such as, for example, a moving image, a picture, and a preset menu screen.

The memory unit 9 records and stores operations of each function unit, and may store signals or data input and output corresponding to operations of the input unit 3 and the video display unit 6, according to the control by the controller 1. In addition, the memory unit 9 may store control programs and applications for control of apparatuses or the controller 1.

The controller 1 generally controls each functional unit of the input unit 3, the video display unit 6, and the memory unit 9. In addition, the controller 1 includes a color vision characteristic determining unit 10 that determines user color vision characteristics by receiving or selecting the kind of color vision defect or the degree of color vision defect selected by a user through execution of a preset user color vision characteristic input menu via the input unit 3. In addition, the controller 1 includes a video hue transformation unit 20 that transforms a preset basic hue table of a terminal according to user color vision characteristics, and that transforms hues of a video to be displayed on the video display unit 6 by applying the transformed basic hue table.

In detail, the color vision characteristic determining unit 10 presets degrees of the color vision defect, quantified from 0 to 1.0, for all kinds of color vision defects, including, for example, red-green blindness, red-green weakness, blue weakness, and the like. The color vision characteristic determining unit 10 stores the kind of color vision defect selected by the user from the displayed preset color vision defects.

In addition, a plurality of example videos, which are preset according to the degree of color vision defect for the kind of color vision defect, are displayed. The degree of color vision defect based on the example videos selected by the user is determined and stored. The plurality of preset example videos are videos preset so that a person with a corresponding color vision defect may distinguish the videos easily according to the seriousness of each color vision defect. Specifically, among the plurality of the displayed preset example videos, the user selects a video that the user can easily distinguish colors thereof, and the degree of preset color vision defect corresponding to the selected video is stored.

In addition, the color vision characteristic determining unit 10 may have a configuration of receiving and storing the kind of color vision defect and the degree of color vision defect from the user. Specifically, if the user knows his/her own kind or degree of color vision defect among the kinds of preset color vision defect examples and the degrees of preset color vision defect, the user may input his/her own kind or degree of color vision defect.

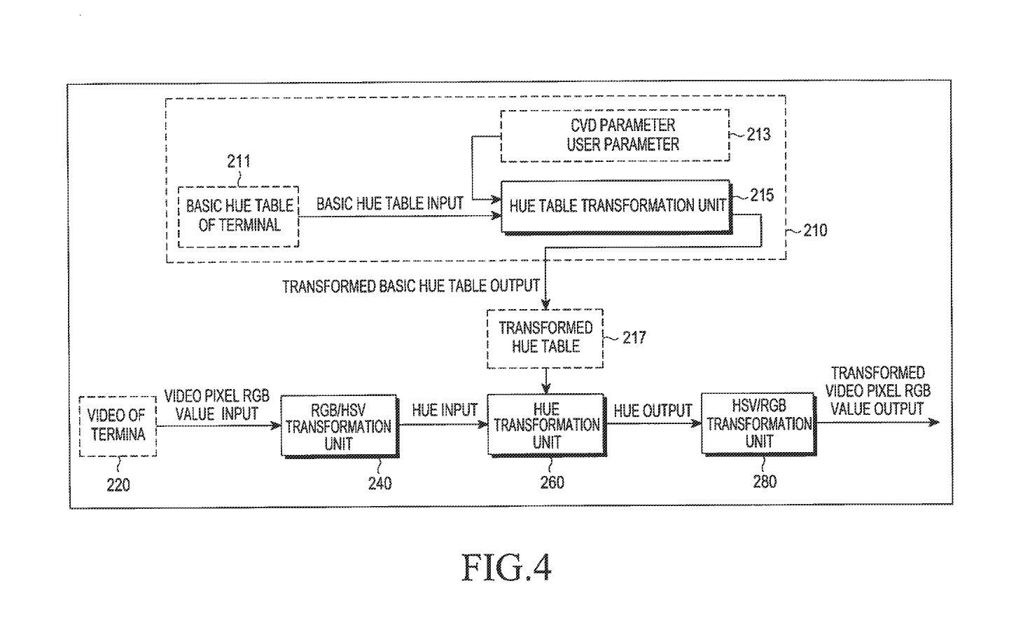

FIG. 4 is a detailed block diagram illustrating the video hue transformation unit 20 in FIG. 3, according to an embodiment of the present invention. With reference to FIG. 4, the detailed configuration of the video hue transformation unit 20 includes a basic hue table transformation unit 210 that transforms and stores a basic hue table 211 having preset hue information of a terminal, according to the color vision characteristics of the user determined by the color vision characteristic determining unit 10.

The basic hue table transformation unit 210 determines Color Vision Deficiency (CVD) parameters that designate the reduction degrees of a hue section of an HSV color space and user hue parameters that designate the expansion degrees of a hue section, according to the color vision characteristics of the user. In addition, a basic hue table is transformed and stored by applying the determined CVD parameters and the determined user hue parameters.

In addition, the detailed configuration of the video hue transformation unit 20 includes an RGB/HSV transformation unit 240 that transforms an RGB video pixel value of a video to be displayed into an HSV color space, a hue transformation unit 260 that transforms a video hue of a video to be displayed by using a transformed basic hue table in a HSV color space, and an HSV/RGB transformation unit 280 that transforms the HSV color space back to the RGB video pixel value.

An operation of a hue transformation apparatus for a person with a color vision defect having the configurations as described above is described in detail as follows.

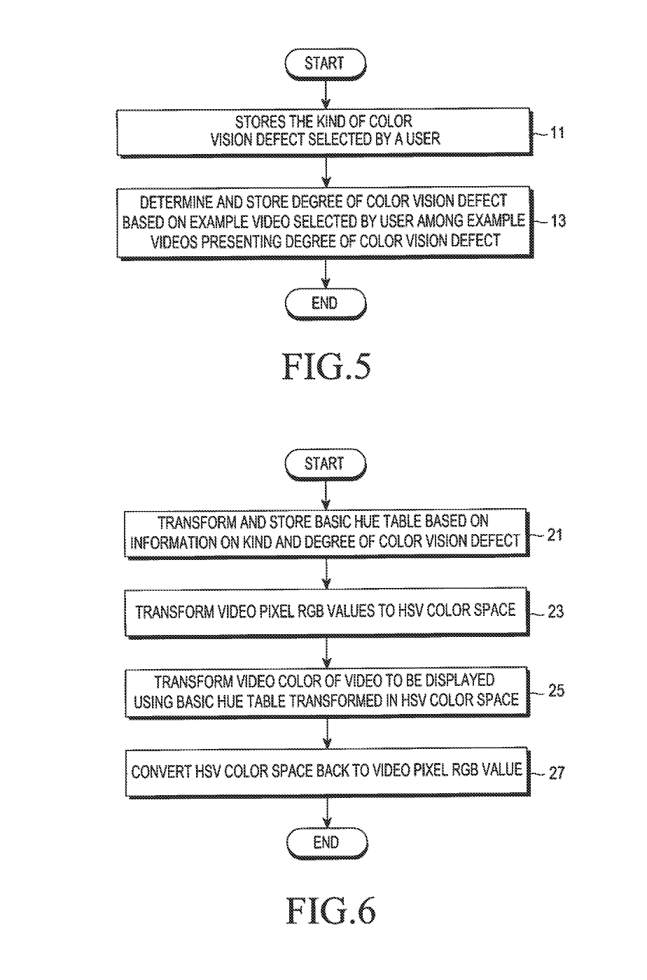

FIG. 5 is a flowchart illustrating a process of determining color vision characteristics in color formation operations for a person with a color vision defect, according to an embodiment of the present invention.

With reference to FIG. 5, the process of determining the color vision characteristics first stores the kind of color vision defect selected by a user among the displayed preset color vision defect examples, in step 11.

That is, if a program that transforms colors for a person with a color vision defect, according to an embodiment of the present invention, is executed by the selection of the user, the terminal displays a menu that determines preset color vision characteristics. In addition, if the menu that determines preset color vision characteristics is executed according to the selection of the menu that determines preset color vision characteristics by the user, the terminal displays a screen that determines the kind of color vision defect. At this point, the displayed screen that determines the kind of color vision defect includes all kinds of color vision defect examples such as red blindness, yellow blindness, and green weakness, and stores the kind of color vision defect selected by the user among the kinds of color vision defect examples.

When step 11 is completed, the terminal displays a screen that determines the degree of preset color vision defect. The screen that determines the degree of the color vision defect displays a plurality of example videos that are preset according to the degree of color vision defect for each kind of color vision defect, and determines and stores the degree of color vision defect based on the example video selected by the user, in step 13. In addition, the plurality of preset example videos are videos that are preset so that a person with a corresponding color vision defect may distinguish the videos easily according to the seriousness of each color vision defect. The degrees of color vision defect are quantified from 0 to 1.0.

An operation of determining color vision characteristics can be performed as described above, and further, a process of determining color vision characteristics may perform, for example, an operation of receiving and storing the kind of color vision defect and the degree of color vision defect from the user. Specifically, if the user knows his/her own kind or degree of color vision defect among the kinds of preset color vision defect examples and the degrees of preset color vision defect, the user may input his/her own kind or degree of color vision defect.

FIG. 6 is a flowchart illustrating a process of transforming video colors in a color transformation operation for a person with a color vision defect, according to an embodiment of the present invention. In the process, the colors of a video are transformed by transforming a hue among a hue, a saturation, and a value, in an HSV color space.

With reference to FIG. 6, the video color transformation process transforms a preset basic hue table of a terminal according to the determined color vision characteristics, in step 21, and the detailed description thereof will follow below. Thereafter, in step 23, in order to transform colors of a video to be displayed in the HSV color space, RGB video pixel values of the video to be displayed is transformed to the HSV color space. Thereafter, in step 25, various colors of the video to be recognized by the user are transformed in the HSV color space. In step 25, the hue of the video to be displayed is transformed by using the transformed basic hue table. Thereafter, in step 27, in order to display the transformed video on the screen of the terminal, the HSV color space is transformed back to the RGB video pixel value.

Step 21 is a step performed only one time at first, when the terminal applies the color transformation for a person with a color vision defect. In practice, when the terminal displays a video, the hue table configured in step 21 is loaded to transform colors of the video to be displayed on the terminal through the processes of steps 23 to 27.

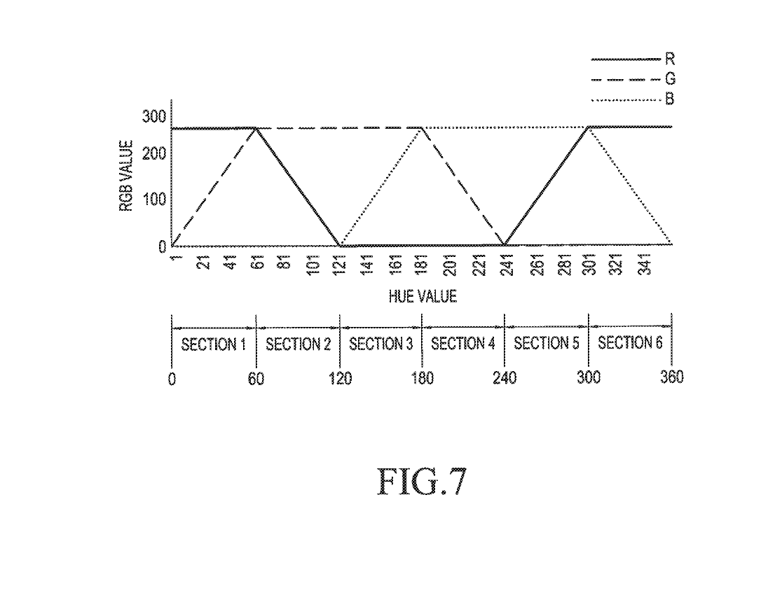

FIGS. 7 to 12 provide a detailed description on the step of transforming a preset basic hue table of the terminal, according to the color vision characteristics determined in step 21.

First, in step 21, a configuration is made by dividing the entire hue scope of the HSV color space into a plurality of hues by 60 degrees.

FIG. 7 is a graph illustrating an example of presenting hues of a basic hue table applied in an embodiment of the present invention with RGB values. In the graph, a configuration is made by dividing the scope of hue values in the RGB values into 6 hues by 60 degrees. However, FIG. 7 has been presented to indicate the hues of the basic hue table into RGB values for better understanding of the present invention, and in step 21, an operation is made in the HSV color space, not with RGB values.

Further, CVD parameters that designate the reduction degrees of a hue section and user hue parameters that designate the expansion degree of a hue section are determined according to the determined color vision characteristics of the user. The CVD parameters and the user hue parameters are values that are preset and stored for each of the preset color vision characteristics, or a function capable of configuring the CVD parameters and the user hue parameters by an operation of the user may be added. Specifically, by performing a configuration in advance so that the CVD parameters and the user hue parameters can be reconfigured, a function may be added so that the user may change each value according to how much he/she desires to distinguish colors. In addition, the reduction or expansion of the hue section is to reduce or expand the initially determined hue scope, and to change HSV values corresponding to the values at both ends of the initial hue scope in the hue section to correspond to the values at both ends of the reduced or expanded hue scope in the hue section.

That is, the hue scope is initially configured by dividing the hue scope into six sections each with 60 degrees so that the basic hue table can be transformed by the expansion or reduction of the hue section initially configured by determining the characteristics of each section.

The transformation of the basic hue table determines a standard hue value, which is a standard of no hue transformation in the transformation of the basic hue table. The standard hue value is a hue value from a hue distribution of the HSV color space, which is preset so that a person with a color vision defect may see the hue value as seen by a normal vision.

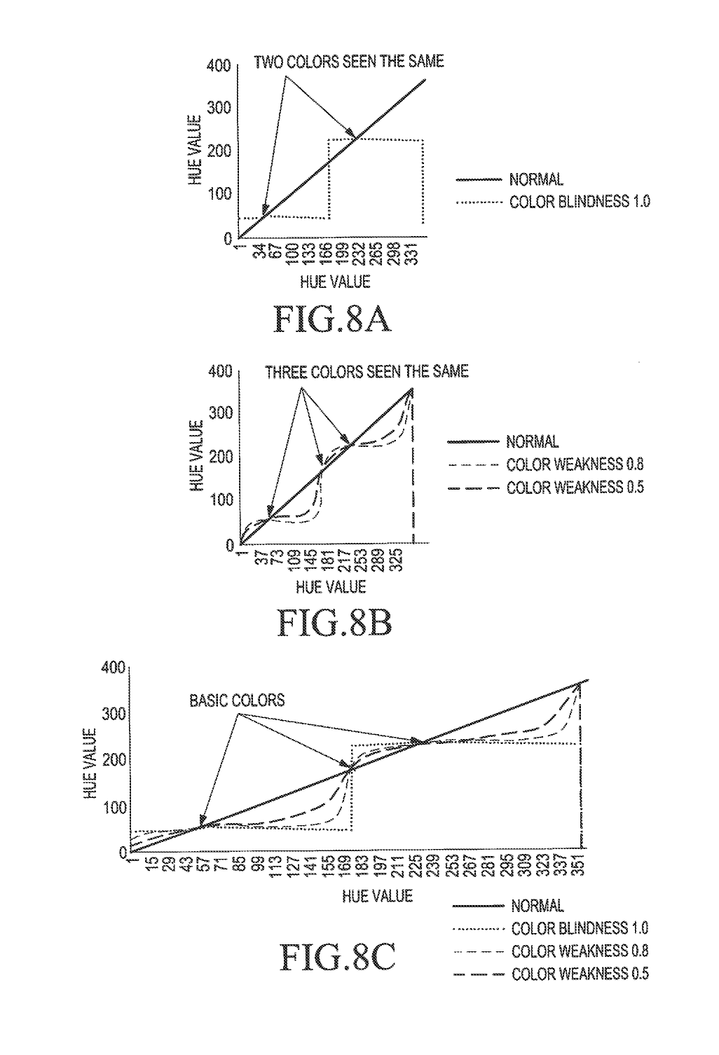

FIGS. 8A to 8C are graphs illustrating examples of hue recognition states of a person with a color vision defect and a normal person. FIG. 8A is a graph illustrating an example in which a person with color blindness recognizes only two hue values out of hue values recognized by a person with a normal vision. FIG. 8B is a graph illustrating an example in which two people with color weakness of the same kind but different degrees recognize only three hue values out of hue values recognized by a person with normal vision. Further, FIG. 8C is a graph illustrating an example in which people with the same color weakness regardless of the degrees of the color weakness see three hue values as seen by a person with normal vision, and a person with color blindness sees a hue value at a point where a hue changes and hue values at the other two points as seen by a person with color weakness and a person with a normal vision.

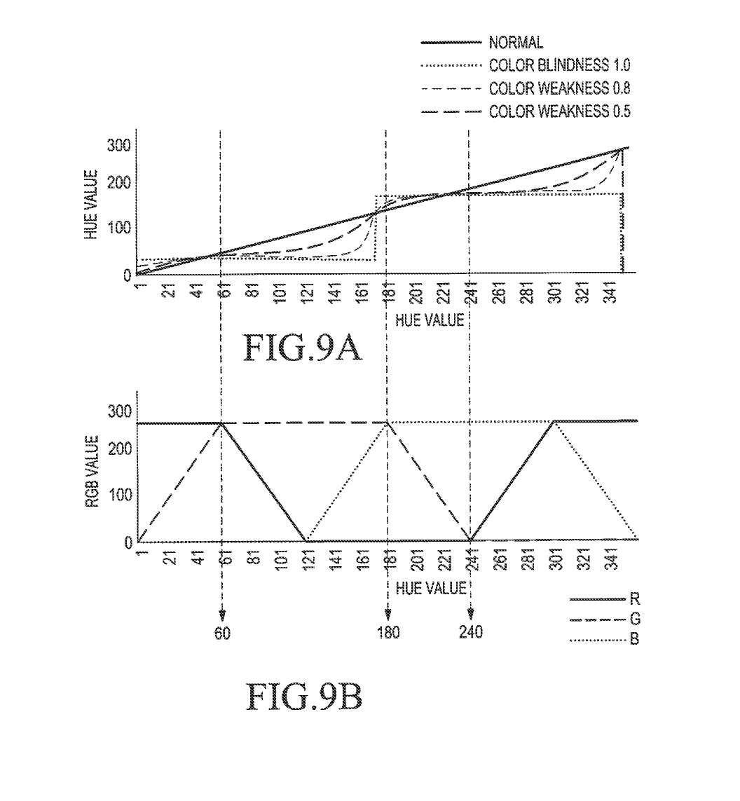

FIGS. 9A and 9B are graphs illustrating examples of presenting a standard hue value with hue values and RGB values in order to describe transformation of a basic hue table, according to an embodiment of the present invention. The graph illustrates an example of determining a standard hue value which is a standard of no hue transformation in the transformation of the basic hue table. With reference to FIGS. 9A and 9B, in the case of red-green blindness, standard hue values are determined with 60, 180, and 240 degrees of hue values at which hue values are seen as seen by a normal person without a color vision defect, a person with color blindness of 1.0 whose kind of color vision defect is color blindness, a person with color weakness of 0.8 whose kind of color vision defect is color weakness and whose color weakness is serious, and a person with color weakness of 0.5 whose color weakness is less serious than the person with color weakness of 0.8.

Thereafter, the transformation of the basic hue table changes a hue section in which a hue, saturation, and value are constant by applying a CVD parameter and a standard hue value. Among hue sections in the HSV color space, a hue section in which a hue, saturation, and value are constant is not distinguished by a person with a color vision defect. Therefore, the hue section is determined as a reduction section. The reduction section is reduced by the CVD parameter from a point having a hue value which is greatly different from the standard hue value of the hue scope in the reduction section. Lastly, a hue section neighboring the point having a hue value which is greatly different from the standard hue value in the reduced reduction section is expanded by the reduced size.

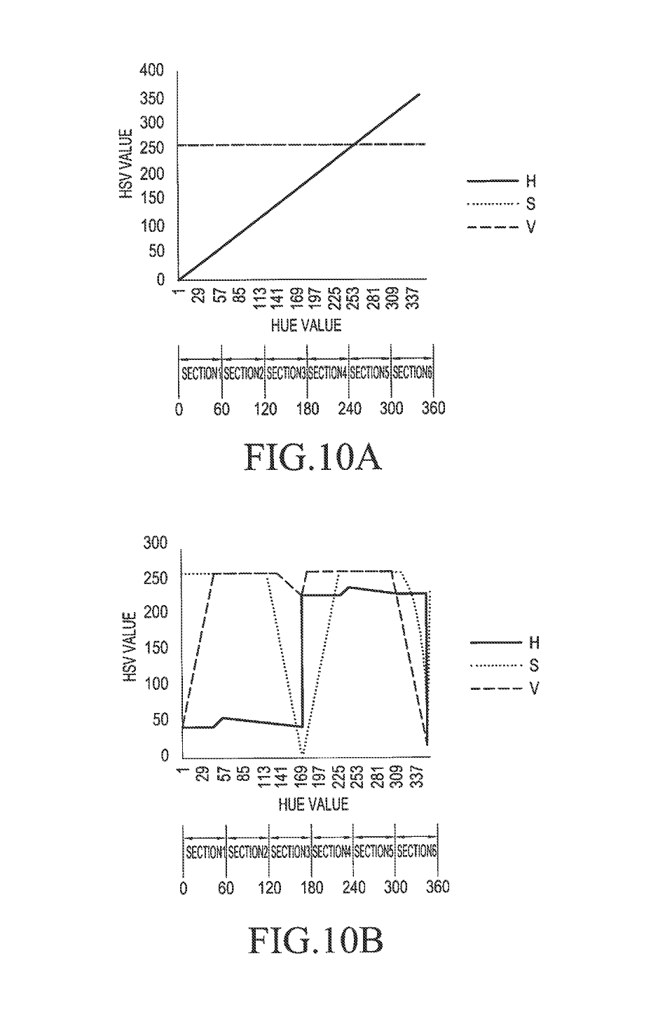

FIGS. 10A and 10B are graphs illustrating examples presenting hues recognized by a normal person and a person with red-green blindness with HSV values. FIG. 10A is a graph illustrating an example presented by HSV values with respect to hue values of a normal vision.

FIG. 10B is a graph illustrating an example presented by HSV values with respect to hue values of color vision defect. The HSV values with respect to the hue values of the normal vision are distinguished by all different hues from section 1 to section 6. In addition, the HSV values with respect to the hue values of the color vision defect present only two hues, and saturation and values in a normal vision are changed.

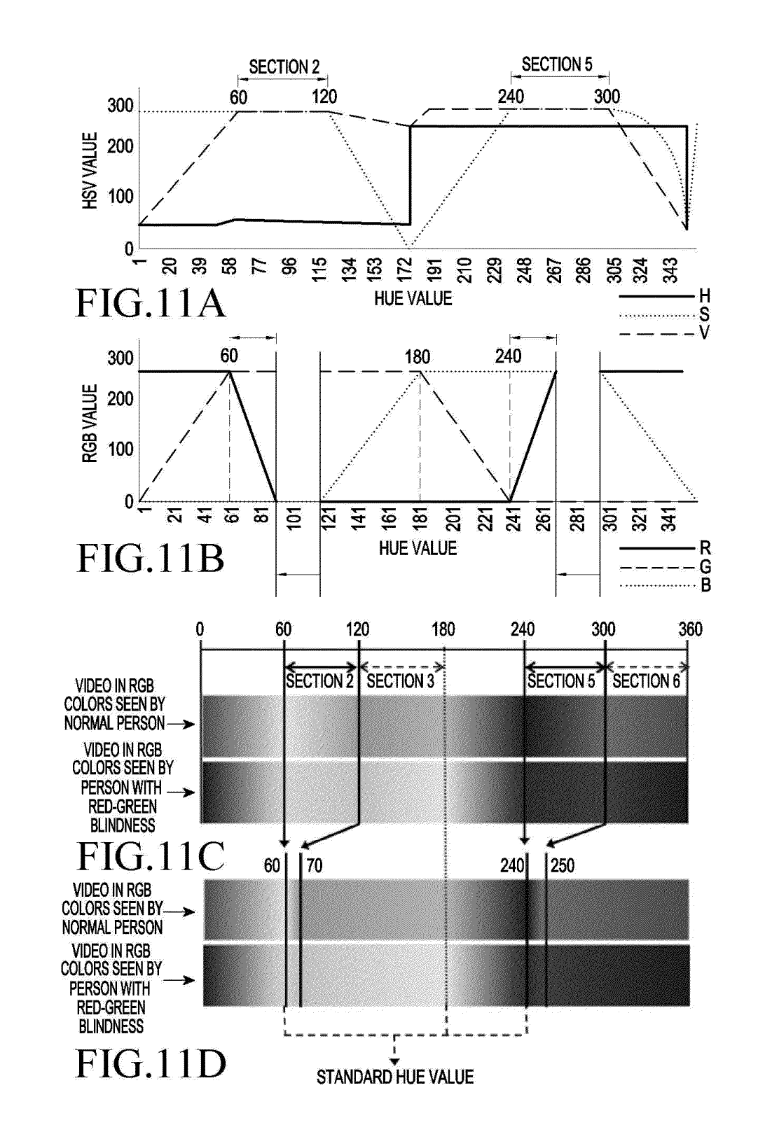

FIGS. 11A to 11D are graphs illustrating examples of transforming a hue section which is indistinguishable and recognized as the same color by a person with a color vision defect in the case of red-green blindness, according to an embodiment of the present invention. With reference to FIGS. 11A to 11D, in the case of red-green blindness, sections 2 and 5 of the hue sections in which hues, saturation, and values are constant with no change are determined as reduction sections. Thereafter, section 2 is reduced by a CVD parameter from a point having a value greatly different from the standard hue value of 60 in section 2. Thereafter, section 3 neighboring the point having the hue value greatly different from the standard hue value of 60 in reduced section 2 is expanded by the reduced size. In addition, section 5 is reduced by the CVD parameter from the point having a value greatly different from the standard hue value of 240 in section 5. Thereafter, section 6 neighboring the point having the hue value greatly different from the standard hue value of 240 in reduced section 5 is expanded by the reduced size.

In addition, the transformation of the basic hue table changes a hue section in which a value decreases or increases in a constant ratio, among the hue sections. Among the hue sections in the HSV color space, a hue section in which a value decreases or increases in a constant ratio is determined as a change section. In addition, according to the kind of color vision defect, a section having a hue which is not distinguished from the hue of the change section is determined as a comparison section. A section among the change section neighboring the comparison section is reduced by the CVD parameter, and another section among the change section is expanded by a user variable.

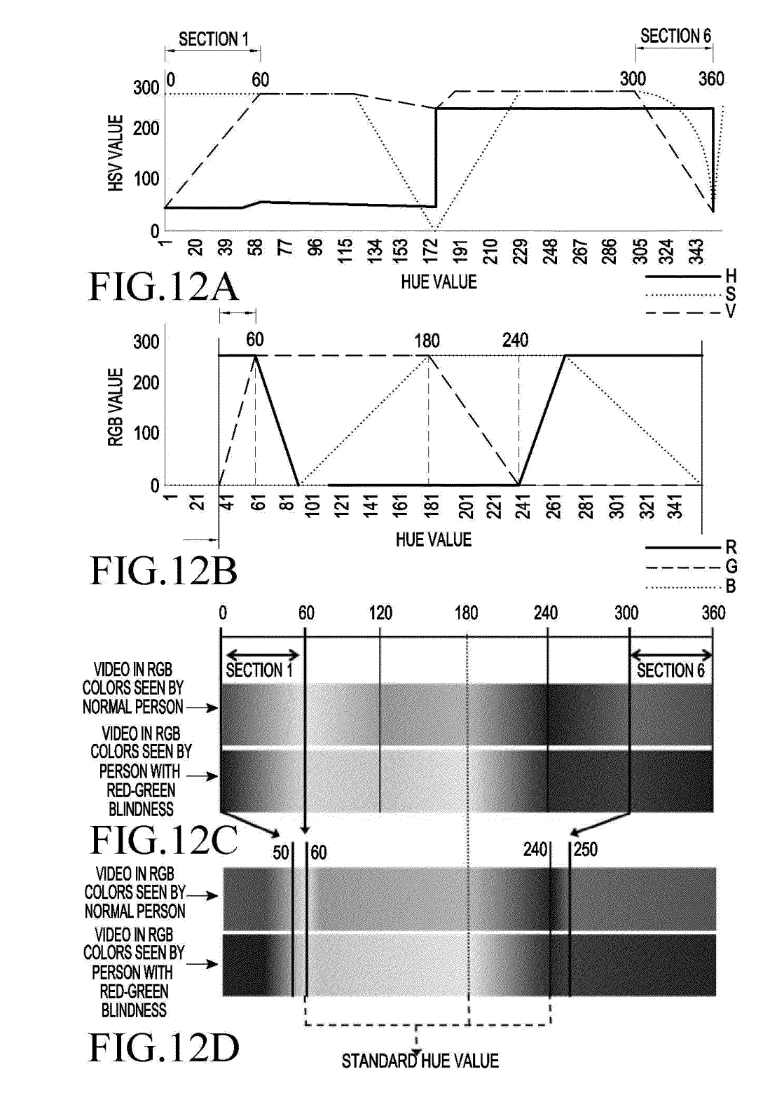

FIGS. 12A to 12D are graphs illustrating examples of transforming a hue section which is not distinguished according to a kind of color vision defect, in the case of red-green blindness, according to an embodiment of the present invention. With reference to FIGS. 12A to 12D, in the case of red-green blindness, sections 1 and 6 which are hue sections of a red color, in which a value increases or decreases in a constant ratio, are determined as change sections. In addition, according to red-green blindness, which is a kind of color vision defect, sections 2 and 3 of a green color which is not distinguishable from a red color are determined as comparison sections. At this point, both sections 1 and 6 are red, but section 1 is red that is not distinguished from sections 2 and 3, and section 6 is red that is distinguished from sections 2 and 3. Therefore, distribution of hues is transformed so that red and green is distinguished from each other by reducing section 1, which neighbors the comparison sections of sections 2 and 3 and which is red that is not distinguishable from a green color by the CVD parameter, and expanding section 6, which is red that is distinguishable from a green color by the user variable.

The transformation of the basic hue table quantifies hue values in the basic hue table and hue values in the transformed basic hue table to have non-linear relation by further applying histogram equalization when a hue section or a change section is expanded. In the case of the linear relation, the characteristics of a video are not correctly reflected, but when the hue section or the change section is expanded in the transformation of the hue table in order to correctly reflect the characteristics of a video, input hue values and output hue values may be quantified to have a non-linear relation by applying histogram equalization. Human beings more easily recognize colors not by brightness of a video, but by increases in contrast between brightness and darkness. The histogram equalization enables the colors of the video to be easily recognized by distributing pixel values in a video of which the pixel values are focused in a small range, to a whole range, thereby increasing contrast between brightness and darkness.

Specifically, the color transformation for a person with a color vision defect, according to an embodiment of the present invention, reduces a hue section that is not distinguished by a person with a color vision defect, expands a hue section that neighbors the reduced hue section and that is distinguished by a person with a color vision defect, so that a person with a color vision defect can recognize hues.

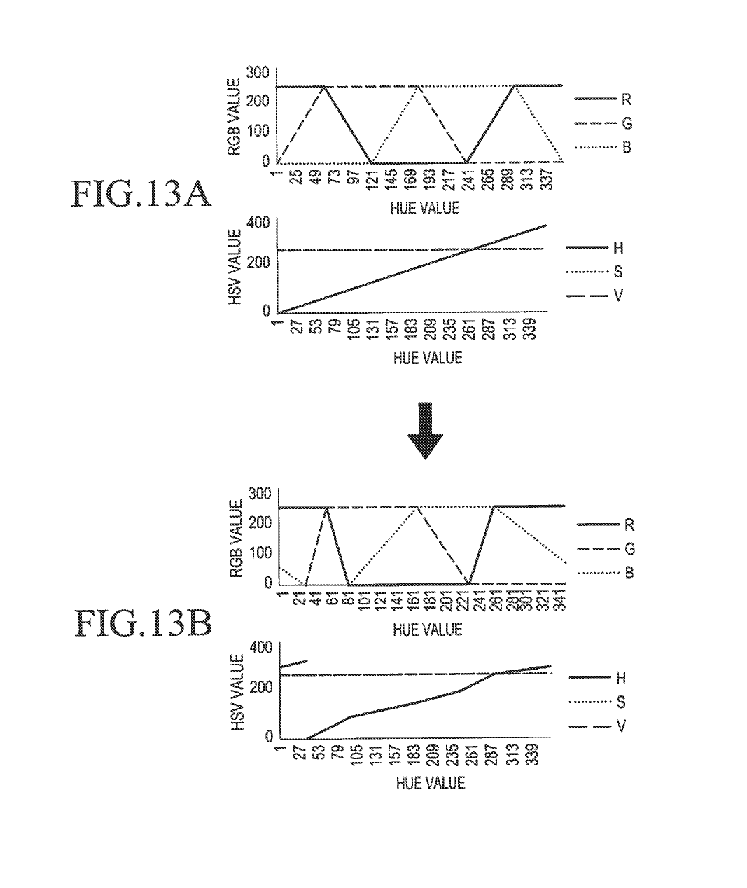

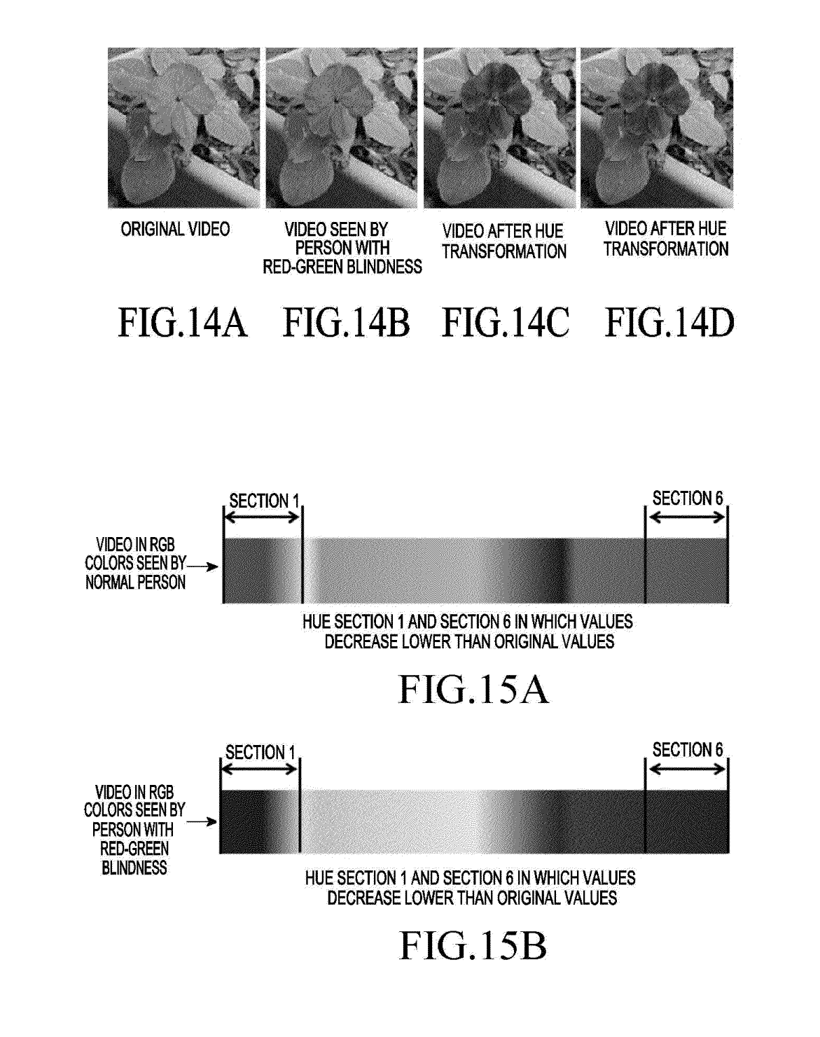

FIGS. 13A and 13B are graphs illustrating examples of presenting hues in a basic hue table and a transformed basic hue table of red-green blindness, according to an embodiment of the present invention. FIG. 13A is a graph in which a hue graph of a basic hue table which is not transformed is presented with RGB and HSV in a method of video color transformation, according to an embodiment of the present invention. In addition, FIG. 13B is a graph in which a hue graph of a transformed basic hue table in the case of red-green blindness is transformed into RGB and HSV in a method of video color transformation, according to an embodiment of the present invention.

FIGS. 14A to 14D are diagrams illustrating examples of a video before and after hue transformation. FIG. 14A is an original video, FIG. 14B is a video seen by a person with red-green blindness, FIG. 14C is a video after hue transformation, and FIG. 14D is a video after hue transformation to which user hue parameter which is greater than a value in FIG. 14C is applied.

According to another embodiment of the present invention, in the case of red-green color vision defects, a color transformation operation for a person with a color vision defect can be performed by correcting hues and values. The correction of valuest may solve a problem in which colors appear dark when values are not corrected.

FIGS. 15A and 15B are graphs illustrating an example of a hue section in which values of colors seen by a person with red-green blindness are lower than values of colors seen by a normal person, according to another embodiment of the present invention. FIG. 15A is a video in RGB colors as seen by a normal person, and FIG. 15B is a video in RGB colors as seen by a person with red-green blindness. The values of colors in sections 1 and 6 of the hue sections of FIG. 15B decrease lower than values of colors seen by a normal person.

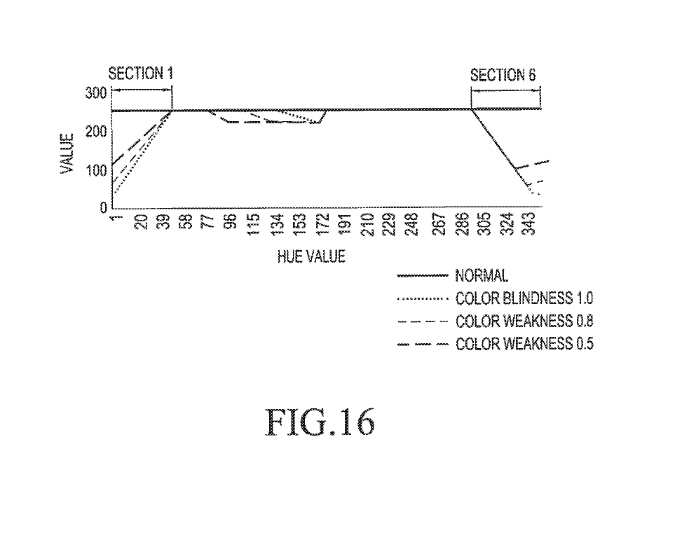

FIG. 16 is a graph illustrating an example of presenting a change in values with respect to hues according to the degree of color vision defect in the case of red-green blindness, according to another embodiment of the present invention. In the graph, normal refers to a person with no color vision defect, color blindness 1.0 refers to a person has color blindness, color weakness 0.8 refers to a person having a serious degree of color weakness, and color weakness 0.5 refers to a person having a less serious degree of color weakness 0.8. Regarding the change in value with respect to hue, according to the degree of color vision defect in sections 1 and 6 in which values decrease or increase in a constant ratio, the difference in value from the normal becomes greater as color vision defect is more serious.

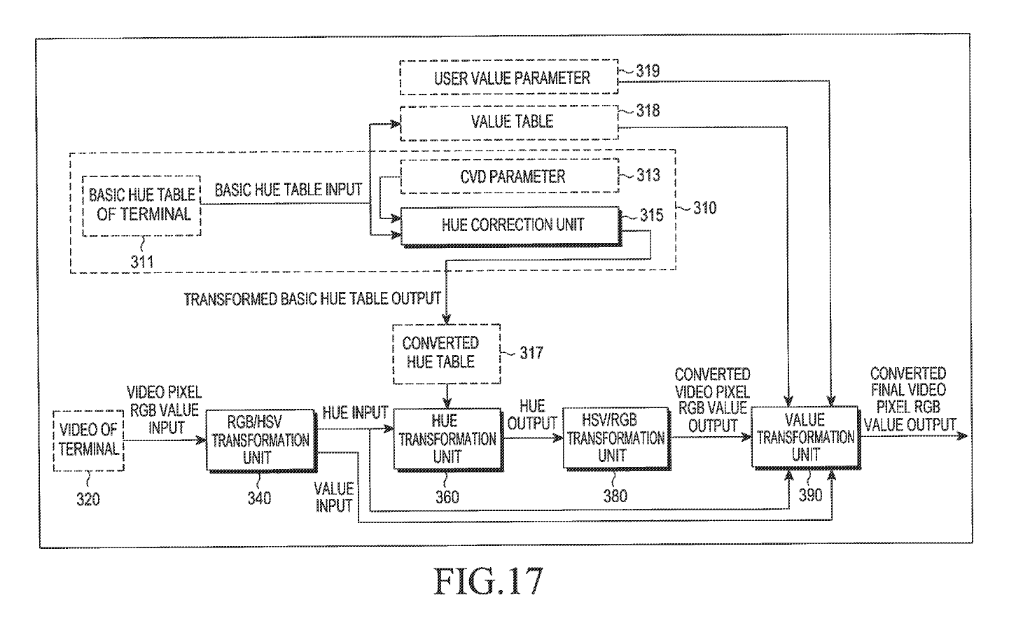

FIG. 17 is a detailed block diagram illustrating a video hue transformation unit 20 in the case of red-green color vision defect, according to another embodiment of the present invention. With reference to FIG. 17, the detailed configuration of the video hue transformation unit 20 includes a basic hue table transformation unit 310 that transforms and stores a basic hue table 311 having preset hue information of a terminal, according to the color vision characteristics of a user which is determined by the color vision characteristic determining unit 10. The basic hue table transformation unit 310 determines CVD parameters 313 designating the degree of reduction in the hue section of the HSV color space, according to the color vision characteristics of the user, and transforms a basic hue table through partial correction of hues in the hue correction unit 315 by applying the determined CVD parameters 313 and stores in the converted hue table 317.

The detailed configuration of the video hue transformation unit 20 also includes a RGB/HSV transformation unit 340 that transforms RGB video pixel values of a video to be displayed into an HSV color space, a hue transformation unit 360 that transforms video hues of the video to be displayed by using the converted hue table 317 in the HSV color space, and an HSV/RGB transformation unit 380 that transforms the HSV color space back to the RGB video pixel values.

In addition, the video hue transformation unit 20 includes a value transformation unit 390 that performs transformation by correcting values in a section in which values decrease or increase in a certain ratio in the HSV color space, in the case of the red-green color vision defect. The value transformation unit 390 receives and transforms values in the RGB/HSV transformation unit 340, by determining and applying preset user value parameters 319 designating a correction degree of the values corresponding to the hues in the HSV color space, according to the color vision characteristics of the user, applying values in the value table 318 corresponding to hues in the RGB/HSV transformation unit 340, and applying B values of transformed RGB pixels in the HSV/RGB transformation unit 380. The value table 318 stores values corresponding to each hue in the basic hue table 311.

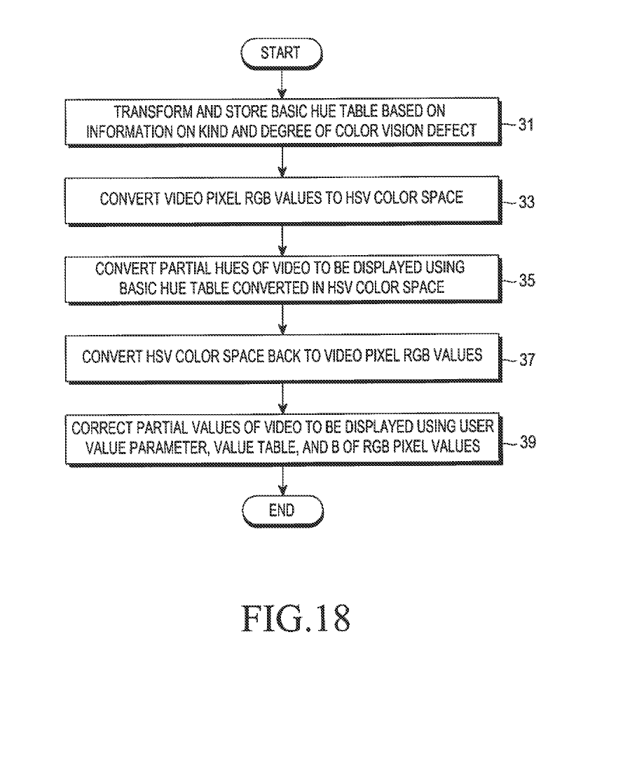

Another embodiment of applying an operation of correcting and transforming hues and values of the video hue transformation unit 20 is described in detail below with respect to FIG. 18.

FIG. 18 is a flowchart illustrating a process of transforming video colors in a color transformation operation for a person with a red-green color vision defect, according to another embodiment of the present invention. With reference to FIG. 18, in step 31, a preset basic hue table of a terminal is transformed according to the determined color vision characteristics. In step 33, RGB video pixel values of the video to be displayed are transformed into the HSV color space in order to transform the colors of the video to be displayed in the HSV color space. In step 35, a part of various colors of the video are transformed to be recognized by the user in the HSV color space. In step 35, colors of the video to be displayed are transformed using the transformed basic hue table. In step 37, the HSV color space is transformed back to the RGB video pixel values. In step 39 a part of values of the video to be displayed is corrected and transformed by using a B value in the RGB video pixel value, a value table, and a user value parameter.

Step 31 is performed once at first, when the terminal applies color transformation for a person with a color vision defect, according to an embodiment of the present invention. In practice, when the terminal displays the video, the terminal loads a hue table configured in step 31, and transforms hues of the video to be displayed on the terminal through the processes of steps 33 to 39.

In step 31, a configuration is performed so that the entire hue scope of the HSV color space is divided into a plurality of hues by 60 degrees.

In addition, according to the color vision characteristics of the user, a CVD parameter that designates the degree of reduction of the hue section is determined. The CVD parameters are values that are preset and stored for each preset color vision characteristic. A function may be added so that the CVD parameter can be configured by an operation of the user. Specifically, a function that enables the user to change each figure according to how much the user desires to distinguish colors can be added by performing configuration in advance so that the CVD parameter can be reconfigured. In addition, the reduction of the hue section is to reduce the initially configured hue scope, and to change HSV values corresponding to values at both ends of the initial hue scope in the hue section to values corresponding to values at both ends of the reduced hue scope in the hue section.

By performing configuration at the initial stage so that the hue scope is divided into 6 sections by 60 degrees, the basic hue table can be transformed by reducing the initially configured hue section by determining characteristics of each section.

Thereafter, by applying the determined CVD parameters, the basic hue table is transformed and stored in the HSV color space.

The transformation of the basic hue table first determines a standard hue value which is a standard of no hue transformation in the transformation of the basic hue table. The standard hue value is a hue value from the hue distribution of the HSV color space, which is preset to be seen by a person with color vision defect as seen by normal vision.

Thereafter, the transformation of the basic hue table changes a hue section in which hues, saturation, and values in the hue section are constant, by applying CVD parameters and the standard hue value. Among the hue sections of the HSV color space, a hue section in which hues, saturation, and values are constant is a section that is indistinguishable and recognized as the same hue by a person with a color vision defect, so the hue section is determined as a reduction section. The reduction section is reduced by a CVD parameter from a point having a hue value that is greatly different from the standard hue value of the hue scope in the reduction section. Lastly, a hue section neighboring the point having a hue value which is greatly different from the standard hue value in the reduced reduction section is expanded by the reduced size. The reduction or the expansion of the hue section is to reduce or expand the initially configured hue scope, and to change HSV values corresponding to the values at both ends of the initial hue scope in the hue section to correspond to the values at both ends of the reduced or expanded hue scope in the hue section.

The transformation of the basic hue table can quantify hue values in the basic hue table and hue values in the transformed basic hue table to have non-linear relation by further applying histogram equalization when a hue section or a change section is expanded.

In step 39, among the hue sections in the HSV color space, a hue section in which a value decreases or increases in a constant ratio is determined as a change section. Value correction is performed by applying Equation (1) below to transform the B value among the RGB video pixel value in the step of transforming the HSV color space back to the RGB video pixel value in the change section.

B′=B+(ΔV×μ) (1)

In Equation (1), B′ is a B value on which value correction is performed, and B is a B value among the RGB video pixel value when the HSV color space is transformed back to the RGB video pixel value. In addition, ΔV is a value in a value table, and the value table is preset by storing values corresponding to each hue value of the basic hue table. In addition, μ is a correction degree of values corresponding to hues in the HSV color space, as a user value parameter is applied by a value from 0 to 1, and is determined according to the determined user color vision characteristics.

According to another embodiment of the present invention, in the case of a blue color vision defect, a color transformation operation for a person with a color vision defect may be performed by correcting and transforming only values without hue transformation.

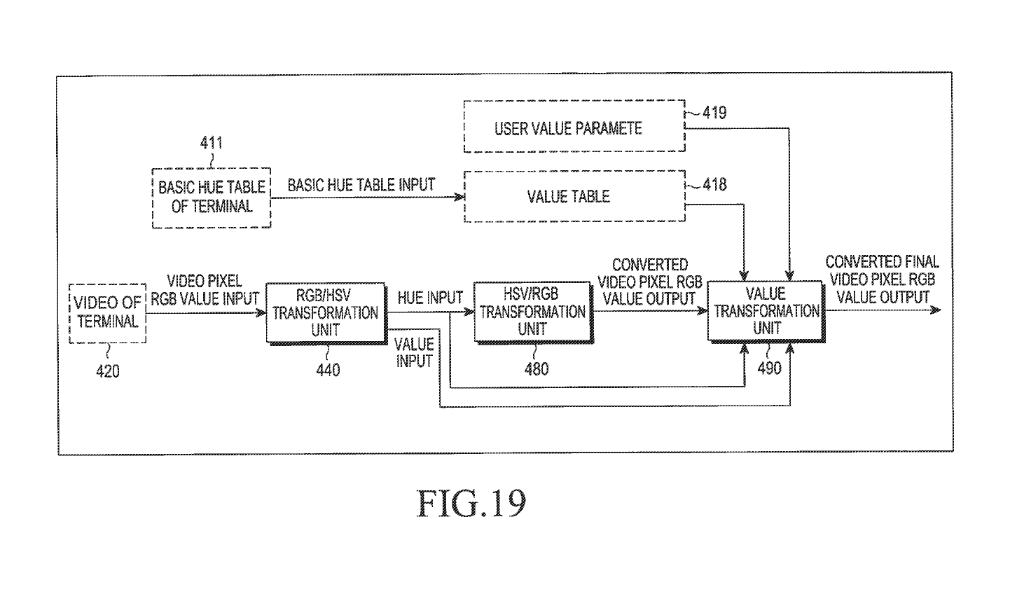

FIG. 19 is a detailed block diagram illustrating a video hue transformation unit in the case of a blue color vision defect, according to another embodiment of the present invention. With reference to FIG. 19, the detailed configuration of the video hue transformation unit 20 includes an RGB/HSV transformation unit 440 that transforms RGB video pixel values of a video of terminal 420 to be displayed to an HSV color space, an HSV/RGB transformation unit 480 that transforms the HSV color space back to the RGB video pixel values, and a value transformation unit 490 that performs transformation by correcting values in a section in which values decrease or increase in a constant ratio in the HSV color space. The value transformation unit 490 receives and transforms values in the RGB/HSV transformation unit 440, by determining and applying preset user value parameters 419 designating a correction degree of the values corresponding to the hues in the HSV color space according to the color vision characteristics of the user, applying values in the value table 418 corresponding to hues in the RGB/HSV transformation unit 440, and applying R values of transformed RGB pixels in the HSV/RGB transformation unit 480. The value table 418 stores values corresponding to each hue in the basic hue table 411.

In the case of the blue color vision defect, another embodiment of applying an operation of correcting and transforming value of the video hue transformation unit 20 is described in detail below.

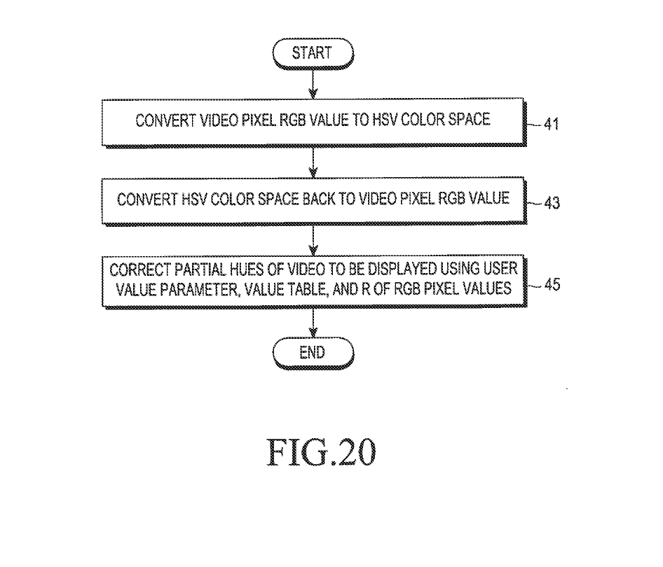

FIG. 20 is a flowchart illustrating a process of transforming the video colors in the color transformation operation for a person with a blue color vision defect, according to another embodiment of the present invention. With reference to FIG. 20, in step 41, the RGB video pixel values of the video are transformed to be displayed into the HSV color space, in order to use hues and values in the HSV color space in the value transformation described below. In step 43, the HSV color space is transformed back to the RGB video pixel value in order to use the R value of the RGB video pixel value for value transformation described below. In step 45 a part of values in the video to be displayed are corrected and transformed by using the B value of the RGB video pixel value, a value table, and a user value parameter.

In step 45, after performing configuration so that the entire hue scope of the HSV color space is divided into 6 sections by 60 degrees, it is determined that a hue section in which the value decreases and increases in a certain ratio among the hue sections of the HSV color space is the change section. Value correction is performed to transform the R value of the RGB video pixel value in the step of transforming the HSV color space back to the RGB video pixel value in the change section by applying Equation (2) below.

R′=R+(ΔV×μ) (2)

In Equation (2), R′ is an R value on which value correction is performed, and R is an R value of the RGB video pixel value when the HSV color space is transformed back to the RGB video pixel value. In addition, ΔV is a value of the value table, and the value table is preset by storing the value corresponding to each hue of the basic table. In addition, μ is a correction degree of values corresponding to hues in the HSV color space, as a user value parameter is applied by a value from 0 to 1, and is determined according to the determined user color vision characteristics.

The present invention determines the color vision characteristics of the user by executing a program or the like, and enables people with color vision defects to distinguish colors without difficulty by performing color transformation. The present invention can be applied to various terminals such as, for example, a cellular phone, a tablet, a notebook, a camera, a TV, and a PDA.

In an embodiment of the present invention, a method is provided for transforming hues, which is applied to red-green blindness, a kind of color vision defect, but the present invention may be applied to any color vision defect except entire color blindness which does not have all of the three cone cells among the color vision defects.

It should be understood that the embodiment of the present invention can be implemented in a form of hardware, software, and the combination of the hardware and software. The arbitrary software may be stored in, for example, regardless of deletability or rewritablility, a volatile or non-volatile storage device such as Read Only Memory (ROM), a memory such as Random Access Memory (RAM), a memory chip, a device or a integrated circuit, or optically or magnetically writable and at the same time machine-readable (for example, computer-readable) storage medium such as Compact Disc (CD), Digital Versatile Disc (DVD), a magnetic disc, or a magnetic tape. The memory that can be included in the portable terminal may be an example of a program including instructions that implement the embodiments of the present invention or a machine-readable storage medium appropriate for storing programs. Therefore, embodiments of the present invention include a program including a code for implementing an apparatus or a method recited in any claims of the present invention, and a machine-readable storage medium that stores the program. In addition, the program may be electronically transferred by any medium such as a communication signal transmitted via wire or radio connection, and the present invention appropriately includes the equivalents thereof.

As described above, a method and an apparatus of transforming hues for a person with color vision defect, according to an embodiment of the present invention, may be configured or operated.

By using a color transformation method and apparatus for a person with a color vision defect according to the present invention, people with color vision defects may watch a video appropriately transformed according to the characteristics of the ability of individuals in distinguishing colors. Based on the characteristics, embodiments of the present invention are applied to a terminal carried and used by individuals such as, for example, a mobile device, so that a person with a color vision defect may recognize colors without difficulty.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A color transformation method for a person with a color vision defect, the method comprising the steps of:
determining a color vision characteristic of a user by receiving at least one of a kind of color vision defect and a degree of color vision defect selected by the user via a preset user color vision characteristic input menu; and
transforming a preset basic hue table of a terminal according to the color vision characteristic of the user and transforming colors of a video to be displayed by applying the transformed basic hue table.

2. The color transformation method according to claim 1, wherein determining the color vision characteristic of the user comprises:
storing the kind of color vision defect selected by the user from among preset and displayed examples of kinds of color vision defects; and
displaying a plurality of example videos preset according the degree of color vision defect for each kind of color vision defect, and determining and storing the degree of the color vision defect according to an example video selected by the user.

3. The color transformation method according to claim 1, wherein transforming the basic hue table comprises:
performing configuration so that an entire hue scope of the Hue, Saturation, Value (HSV) color space is divided into a plurality of hue sections by 60 degrees;
determining a Color Vision Deficiency (CVD) parameter that designates a reduction degree of the hue sections and a user hue parameter that designates an expansion degree of the hue sections according to the determined color vision characteristic of the user; and
transforming and storing the preset basic hue table in the HSV color space by applying the determined CVD parameter and the determined user hue parameter,
wherein reducing and expanding the hue sections is to reduce or expand an initially configured hue scope and to change HSV values corresponding to values at both ends of the initial hue scope in the hue sections to correspond to values at both ends of the reduced or expanded hue scope in the hue sections.

4. The color transformation method according to claim 3, wherein the CVD parameter and the user hue parameter are configurable by an operation of the user.

5. The color transformation method according to claim 3, wherein transforming and storing the preset basic hue table in the HSV color space comprises:
determining a standard hue value that is a standard of no hue transformation when the preset basic hue table is transformed according to the HSV color space;
changing a hue section in which hues, saturation, and values are constant among the hue sections, by applying the CVD parameter and the standard hue value; and
changing hue sections in which values increase or decrease in a constant ratio, among the hue sections, by applying the CVD parameter, the user hue parameter, and the standard hue value.

6. The color transformation method according to claim 5, wherein changing the hue sections in which values increase or decrease in a constant ratio, among the hue sections comprises:
determining the hue sections in which values increase or decrease in a constant ratio, as change sections;
determining a hue section having hues that are not distinguished from hues in the change section, according to the kind of the color vision defect, as a comparison section; and
reducing a section among the change sections neighboring the comparison section by the CVD parameter, and expanding another section among the change sections by the user hue parameter.

7. The color transformation method according to claim 6, wherein expanding the other section among the change sections by the user hue parameter comprises quantifying hue values in the preset basic hue table and hue values in the transformed basic hue table to have a non-linear relation by applying histogram equalization.

8. The color transformation method according to claim 1, wherein transforming the colors of the video to be displayed comprises:
transforming Red, Green, Blue (RGB) video pixel values of the video to be displayed to an HSV color space;
transforming hues of the video to be displayed by using the transformed basic hue table in the HSV color space; and
transforming the HSV color space back to the RGB video pixel values.

9. The color transformation method according to claim 1, wherein transforming the preset basic hue table comprises:
performing configuration so that an entire hue scope of an HSV color space is divided into a plurality of hue sections by 60 degrees;
determining a CVD parameter that designates a reduction degree of the hue sections according to the determined color vision characteristic of the user; and
transforming and storing the preset basic hue table in the HSV color space by applying the determined CVD parameter;
wherein reducing the hue sections is to reduce an initially configured hue scope and to change HSV values corresponding to values at both ends of the initial hue scope in the hue sections to correspond to values at both ends of the reduced hue scope in the hue sections.

10. The color transformation method according to claim 9, wherein the CVD parameter is configurable by an operation of the user.

11. The color transformation method according to claim 9, wherein transforming and storing the preset basic hue table in the HSV color space comprises:
determining a standard hue value that is a standard of no hue transformation when the preset basic hue table is transformed according to the HSV color space; and
changing a hue section in which hues, saturation, and values are constant by applying the CVD parameter and the standard hue value, among the hue sections.

12. The color transformation method according to claim 5, wherein the standard hue value is a hue value that is preset to be seen by a person with a color vision defect as seen by normal vision, in a hue distribution of the HSV color space.

13. The color transformation method according to claim 5, wherein changing the hue section in which hues, saturation, and values are constant comprises:
determining the hue section in which hues, saturation, and values are constant, as a reduction section;
reducing the reduction section from a point having a hue value which is greatly different from the standard hue value of the hue scope in the reduction section, by the CVD parameter; and
expanding a hue section neighboring the point having a hue value which is greatly different from the standard hue value in the reduced reduction section by the reduced size,
wherein expanding the hue section by the reduced size is to expand an initially configured hue scope and to change HSV values corresponding to values at both ends of the initial hue scope in the hue sections to correspond to values at both ends of the expanded hue scope in the hue sections; and
wherein expanding a hue section neighboring the point having a hue value which is greatly different from the standard hue value in the reduced reduction section by the reduced size comprises quantifying hue values in the basic hue table and hue values in the transformed basic hue table to have non-linear relation by applying histogram equalization.

14. The color transformation method according to claim 11, wherein changing the hue section in which hues, saturation, and values are constant comprises:
determining the hue section in which hues, saturation, and values are constant, as a reduction section;
reducing the reduction section from a point having a hue value which is greatly different from the standard hue value of the hue scope in the reduction section, by the CVD parameter; and
expanding a hue section neighboring the point having a hue value which is greatly different from the standard hue value in the reduced reduction section by the reduced size,
wherein expanding the hue section by the reduced size is to expand an initially configured hue scope and to change HSV values corresponding to values at both ends of the initial hue scope in the hue sections to correspond to values at both ends of the expanded hue scope in the hue sections;
wherein expanding a hue section neighboring the point having a hue value which is greatly different from the standard hue value in the reduced reduction section by the reduced size comprises quantifying hue values in the basic hue table and hue values in the transformed basic hue table to have non-linear relation by applying histogram equalization.

15. The color transformation method according to claim 1, wherein transforming the colors of the video to be displayed comprises:
transforming RGB video pixel values of the video to be displayed to an HSV color space;
transforming hues of the video to be displayed by using the transformed basic hue table in the HSV color space;
transforming the HSV color space back to the RGB video pixel values; and
receiving values in transforming the RGB video pixel values to the HSV color space and transforming the values by determining and applying a preset user value parameter designating a correction degree of the values corresponding to the hues in the HSV color space according to the determined color vision characteristic of the user, applying values in the preset value table corresponding to hues in transforming the RGB video pixel values to the HSV color space, and applying a B value of transformed RGB video pixel values in transforming the HSV color space back to the RGB video pixel values,
wherein the value table stores values corresponding to each hue in the basic hue table.

16. The color transformation method according to claim 15, wherein transforming the values comprises:
determining the hue sections in which values increase or decrease in a constant ratio, among the hue sections in the HSV color space, as change sections;
performing value correction on the B value of RGB video pixel values in transforming the HSV color space back to the RGB video pixel values in the change sections by applying the equation:
B′=B+(ΔV×μ)
where B′ is a B value on which value correction is performed, B is a B value among the RGB video pixel value when the HSV color space is transformed back to the RGB video pixel value, ΔV is a value in a value table, the value table is preset by storing values corresponding to each hue value of the basic hue table, and μ is a correction degree of values corresponding to hues in the HSV color space, as a user value parameter, and is determined according to the color vision characteristic of the user.

17. The color transformation method according to claim 1, wherein, after determining the color vision characteristic of the user, further comprising:
transforming RGB video pixel values of the video to be displayed to an HSV color space;
transforming the HSV color space back to the RGB video pixel values; and
receiving values in transforming the RGB video pixel values to the HSV color space and transforming the values by determining and applying a preset user value parameter designating a correction degree of the values corresponding to the hues in the HSV color space according to the determined color vision characteristic of the user, applying values in the preset value table corresponding to hues in transforming the RGB video pixel values to the HSV color space, and applying an R value of transformed RGB video pixel values in transforming the HSV color space back to the RGB video pixel values,
wherein the value table stores values corresponding to each hue in the basic hue table.

18. The color transformation method according to claim 17, wherein transforming the values comprises:
performing configuration so that an entire hue scope of the HSV color space is divided into a plurality of hue sections by 60 degrees, determining the hue sections in which values increase or decrease in a constant ratio, among the hue sections in the HSV color space, as change sections, and performing value correction on the R value of RGB video pixel values in transforming the HSV color space back to the RGB video pixel values in the change sections by applying the equation:
R′=R+(ΔV×μ)
where R′ is a R value on which value correction is performed, R is a R value among the RGB video pixel value when the HSV color space is transformed back to the RGB video pixel value, ΔV is a value in a value table, the value table is preset by storing values corresponding to each hue value of the basic hue table, and μ is a correction degree of values corresponding to hues in the HSV color space, as a user value parameter, and is determined according to the color vision characteristic of the user.

19. The color transformation method according to claim 15, wherein the user value parameter is configurable by an operation of the user.

20. A machine-readable storage medium that stores a program that performs the color transformation method for a person with a color vision defect, which when executed implements the steps of:
determining a color vision characteristic of a user by receiving at least one of a kind of color vision defect and a degree of color vision defect selected by the user via a preset user color vision characteristic input menu; and
transforming a preset basic hue table of a terminal according to the color vision characteristic of the user and transforming colors of a video to be displayed by applying the transformed basic hue table.

21. A hue transformation apparatus for a person with color vision defect, the apparatus comprising:
an input unit that receives control command from a user;
a video display unit that displays a video; and
a controller that generally controls each functional unit and comprises a color vision characteristic determining unit that determines a color vision characteristic of a user by receiving at lest one of a kind of color vision defect and a degree of color vision defect selected by the user through a preset user color vision characteristic input menu via the input unit, and a video hue transformation unit that transforms a preset basic hue table of a terminal according to the color vision characteristic of the user and transforms colors of a video to be displayed on the video display unit by applying the transformed basic hue table.

22. The hue transformation apparatus according to claim 21, wherein the color vision characteristic determining unit stores the kind of color vision defect selected by the user from among preset and displayed examples of kinds of color vision defects, and displays a plurality of example videos preset according the degree of color vision defect for each kind of color vision defect, and determines and stores the degree of the color vision defect according to an example video selected by the user.

23. The hue transformation apparatus according to claim 21, wherein the video hue transformation unit comprises:
a basic hue table transformation unit that transforms and stores a basic hue table having preset hue information of the terminal according to the color vision characteristics of the user determined by the color vision characteristic determining unit;
an Red, Green Blue (RGB)/Hue, Saturation, Value (HSV) transformation unit that transforms RGB video pixel values of a video to be displayed into an HSV color space;
a hue transformation unit that transforms a video hue of a video to be displayed by using the transformed basic hue table in the HSV color space; and
an HSV/RGB transformation unit that transforms the HSV color space back to the RGB video pixel values.

24. The hue transformation apparatus according to claim 23, wherein the video color transformation unit comprises:
a preset user value parameter that designates a correction degree of the values corresponding to the hues in the HSV color space;
a preset value table that stores values corresponding to each hue of the hue table; and
a value transformation unit that transforms values by receiving values when the RGB video pixel values are transformed to the HSV color space by applying a B value or an R value of the transformed RGB video pixel values.
